(19) United States
(12) Patent Application Publication
(10) Pub. No.: US 2018/0239785 A1
(43) Pub. Date: Aug. 23, 2018

(54) INFORMATION PROCESSING APPARATUS AND NON-TRANSITORY COMPUTER READABLE RECORDING MEDIUM

(71) Applicant: FUJI XEROX CO., LTD., Tokyo (JP)

(72) Inventor: Ryouji TAGUCHI, Kanagawa (JP)

(73) Assignee: FUJI XEROX CO., LTD., Tokyo (JP)

(21) Appl. No.: 15/708,830

(22) Filed: Sep. 19, 2017

(30) Foreign Application Priority Data
Feb. 23, 2017 (JP) 2017-031770

(51) Int. Cl. G06F 17/30

(52) U.S. Cl. CPC G06F 17/30289; G06F 17/30371

(57) ABSTRACT

An information processing apparatus includes a receiving unit that receives an operation request for an object, and a permitting unit that applies an operation executing condition to the object for which the operation request has been made to determine whether to permit an operation on the object, the operation executing condition including a first condition associated with an object within an object group in which the object is included and a second condition for each of multiple elements constituting the object.

### CROSS-REFERENCE TO RELATED APPLICATIONS

This application is based on and claims priority under 35 USC 119 from Japanese Parent Application No. 2017-031770 filed Feb. 23, 2017.

### BACKGROUND

### Technical Field

The present invention relates to an information processing apparatus and a non-transitory computer readable recording medium.

### SUMMARY

According to an aspect of the present invention, there is provided an information processing apparatus including a receiving unit that receives an operation request for an object, and a permitting unit that applies an operation executing condition to the object for which the operation request has been made to determine whether to permit an operation on the object, the operation executing condition including a first condition associated with an object within an object group in which the object is included and a second condition for each of multiple elements constituting the object.

### BRIEF DESCRIPTION OF THE DRAWINGS

Exemplary embodiment of the present invention will be described in detail based on the following figures, wherein:

FIG. 1 is a conceptual module diagram of an exemplary configuration according to the exemplary embodiment;

FIG. 2 illustrates an exemplary system configuration according to the exemplary embodiment;

FIG. 3 illustrates exemplary information shown on a task list screen according to the exemplary embodiment;

FIG. 4 illustrates exemplary information shown on a task edit screen according to the exemplary embodiment;

FIG. 5 illustrates an exemplary data structure of a document configuration information table;

FIG. 6 illustrates an exemplary data structure of a process configuration information table;

FIG. 7 illustrates an exemplary data structure of a process information table;

FIG. 8 illustrates an exemplary data structure of a document information table;

FIG. 9 illustrates an exemplary data structure of a user information table;

FIG. 10 illustrates exemplary information shown on a document-group operation authority setting screen according to the exemplary embodiment;

FIG. 11 illustrates an exemplary data structure of an operation authority table;

FIG. 12 illustrates exemplary information shown on a “Quotation” list screen according to the exemplary embodiment;

FIG. 13 is a flowchart of exemplary processing according to the exemplary embodiment;

FIG. 14 is a flowchart of exemplary processing according to the exemplary embodiment;

FIG. 15 is a flowchart of exemplary processing according to the exemplary embodiment;

FIG. 16 illustrates exemplary information shown on a “Report Printing” operation setting screen for “Purchasing” task according to the exemplary embodiment;

FIG. 17 illustrates an exemplary data structure of an operation authority table;

FIG. 18 illustrates exemplary information shown on a “Task Process” list screen according to the exemplary embodiment;

FIG. 19 is a flowchart of exemplary processing according to the exemplary embodiment;

FIGS. 20A and 20B are flowcharts of exemplary processing according to the exemplary embodiment; and

FIG. 21 is a block diagram illustrating an exemplary hardware configuration of a computer that implements the exemplary embodiment.

### DETAILED DESCRIPTION

An exemplary embodiment of the present invention will be described below with reference to the drawings.

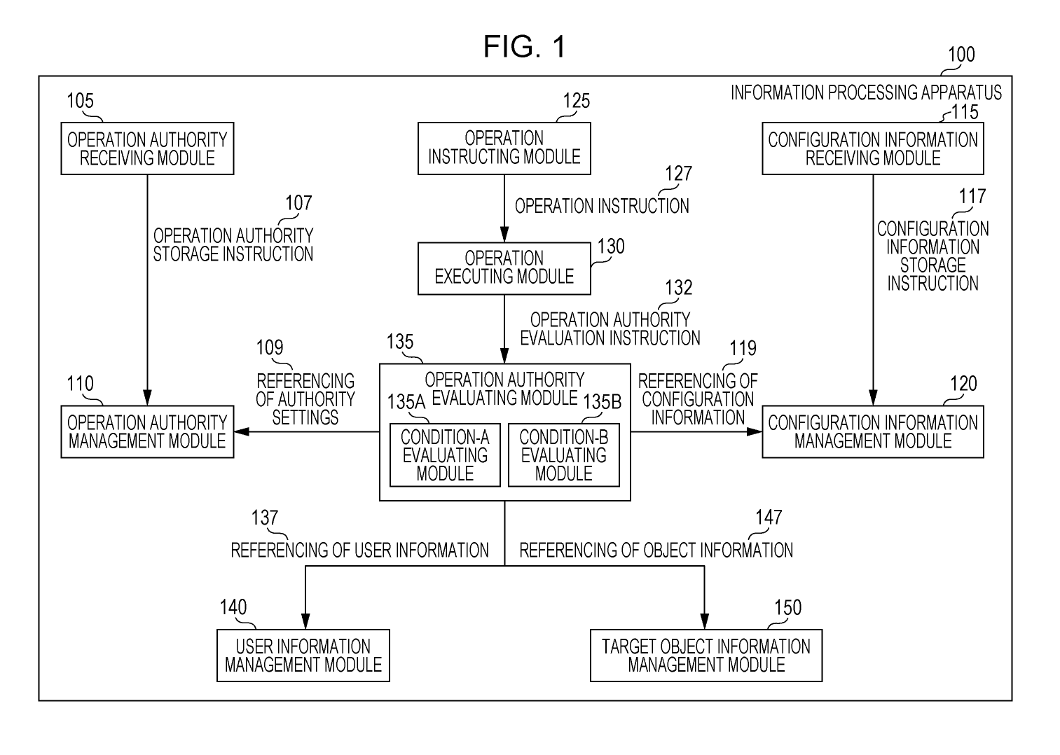

FIG. 1 is a conceptual module diagram of an exemplary configuration according to the exemplary embodiment.

The term “module” generally refers to a logically separable component such as software (computer program) or hardware. Accordingly, the term “module” as used in the exemplary embodiment refers to not only a module in a computer program but also a module in a hardware configuration. Therefore, the exemplary embodiment will be also described also in the context of a computer program for providing functions of such modules (a program for causing a computer to execute individual procedures, a program for causing a computer to function as individual units, or a program for causing a computer to implement individual functions), a system, and a method. Although “store”, “be stored”, and equivalent expressions are used herein for the convenience of description, these expressions mean, when an exemplary embodiment relates to a computer program, “cause a memory to store” or “control a memory so as to store”. Although individual modules and functions may have a one-to-one correspondence, in actual implementation, a single module may be implemented by a single program, or multiple modules may be implemented by a single program. Conversely, a single module may be implemented by multiple programs. Further, multiple modules may be executed by a single computer, or a single module may be executed by multiple computers that are in a distributed or parallel environment. A single module may include another module. In the following description, the term “connection” refers to not only a physical connection but also a logical connection (such as exchanging of data, issuing of an instruction, and cross-reference between data items). The term “predetermined” as used herein means being determined prior to a process of interest, which not only means being determined before processing according to the exemplary embodiment begins but also being determined, even after the processing according to the exemplary embodiment begins, at any point in time preceding a process of interest in accordance with the condition/state at that point in time, or in accordance with the condition/state up to that point in time. If multiple “predetermined values” exist, each of these values may be different, or two or more of these values may be the same (which includes, of course, cases where all of these values are the same). Further, expressions that have the meaning of “if “A” holds, then “B” is performed” is used to mean that “it is determined if “A” holds, and then “B” is performed if it is determined that “A” holds”, unless it is not required to determine if “A” holds. When items are listed in the form “A, B, C”, for example, such a list is intended to be illustrative only unless otherwise specified, and includes cases where only one (e.g., only “A”) of the listed items is selected.

Furthermore, the term “system” or “apparatus” includes not only cases where a system or apparatus is made up of multiple components, such as computers, hardware components, or apparatuses that are connected to each other via a communication medium such as a network (including a one-to-one communication setup), but also cases where a system or apparatus is implemented by a single component such as a computer, a hardware component, or an apparatus. The terms “apparatus” and “system” are herein used synonymously. As a matter of course, the term “system” does not include what is merely a social “mechanism” (social system), which is a man-made arrangement of rules.

Further, for each process executed by each module or, if multiple processes are to be executed within a module, for each of the multiple processes, information of interest is read from a memory, and after execution of the corresponding process, the results of processing are written into the memory. Accordingly, a description about reading of information from a memory prior to a process, or writing of information into a memory after a process will be sometimes omitted. The term “memory” as used herein may include a hard disk, a random access memory (RAM), an external storage medium, a memory using a communication line, and a register in a central processing unit (CPU).

An information processing apparatus 100 according to the exemplary embodiment controls operation authority for an object. As illustrated in FIG. 1, the information processing apparatus 100 includes an operation authority receiving module 105, an operation authority management module 110, a configuration information receiving module 115, a configuration information management module 120, an operation instructing module 125, an operation executing module 130, an operation authority evaluating module 135, a user information management module 140, and a target object information management module 150.

The information processing apparatus 100 relates to a method for assessing operation authority for an object to be managed. In particular, the information processing apparatus 100 relates to an operation authority management method on which the status of an associated object is reflected. Further, the information processing apparatus 100 employs a first condition associated with an object, and a second condition for each element constituting the object.

Although examples of objects to be managed include documents, such objects are not limited to documents but may include any information that can be managed. For example, an object to be managed may be a portion within a document, or may be a process such as a task process. The following description is directed to an example in which such an object is a document. Examples of documents (also called files) include text data, numerical data, graphical data, image data, movie data, audio data, and combinations thereof that are subject to operations such as storage, editing, search, and retrieval and may be exchanged between systems or users as discrete units, and also include data similar to those exemplified above. Specific examples of such data include documents created by document creation programs, images read by image reading devices (e.g., scanners), and Web pages. As for how a process is to be managed according to the exemplary embodiment, it suffices if it is possible to determine the progress of the process based on at least whether any document has been registered in association with the process. For example, it suffices if it is possible to manage, for each document, the approval status, disclosure status, or other status of the document.

First, before describing the exemplary embodiment, a description is given of its underlying idea or an information management system according to the exemplary embodiment. The description given below is intended for the purpose of facilitating the understanding of the exemplary embodiment.

A common method for setting access authority for an object to be managed is to set a bundle of information (access authority list) regarding who has what authority over the object. It is common to assign information such as a user, a user group, or a user role as the information about “who”, and assign a combination of primitive authorities such as the authorities to read, edit, and delete as the information about “what”. If such a method is to be used to manage large quantities of objects, setting authority for each individual object makes the management process cumbersome and prone to setting errors.

A control method is known in which the absence of update authority for a given folder also disables updates to documents under the folders (documents included in the folder). Unfortunately, such a control method is limited to control of specific primitive authorities such as reference and update authorities based on a specific relation such as an inclusion relation. Accordingly, it is hitherto not possible to control authority for a given operation based on a relation between objects that do not have an inclusion relation. In other words, for a given object, it is not possible to set an authority that depends on the state of another object.

For example, it is hitherto not possible to set an operation authority that takes dependence between multiple objects into account, such as an operation authority that permits creation of an acceptance form if an application form has been created, or an operation authority that permits approval to be given once all of the front cover, the body, and the table of contents of a document are in place.

An object includes an element that constitutes the object. In some instances, it is desired to set, as a condition for executing a process on such an element, an element-related condition or a condition that differs for each type of element.

The information processing apparatus 100 executes an operation on an object in accordance with an operation executing condition. The operation executing condition includes a first condition for executing the operation, and a second condition for permitting the operation to be executed for an element within the object.

In particular, the information processing apparatus 100 is capable of setting the relation between multiple objects for which to set operation authority, and using the relation between objects to identify an object or group of objects associated with a specific object.

For example, the structure of a task process made up of multiple steps, and the type of document (object group) created in each individual step may be defined in association with each other. This makes it possible to express the relative relation between documents, such as specific documents (e.g., order forms) for the same project (an instance of task definition), or documents for the same step in the same project.

The relation between documents may not necessarily take the form of a task process structure. Other examples of such relations may include a relation between a copy source and a copy destination, a relation between documents stored in the same folder, and a relation between documents updated at substantially the same instant in time (including documents updated within a predetermined period of time of each other, e.g., one hour).

The information processing apparatus 100 makes it possible to set, as an authority to execute each individual operation, a rule that uses the state of a given object associated with a target object on which to execute the operation.

Examples of information that may be referenced as the state of a target object include a given attribute value associated with the object, and the existence status of the object (such as its presence/absence or the object's count).

For example, it is possible to set a rule such that an approve operation may be executed if all of the documents necessary for the same step are in place, or changes to a document being examined are disabled if an examination results report has been stored.

The information processing apparatus 100 is allowed to specify, as a condition for executing an operation on multiple objects, a condition for each element constituting the target object group. For example, the presence or absence of a specific element may be set as such an execution condition.

This is described below by way of a specific example. For each task, a report printing operation, which prints sheets of paper in the same size and orientation with the front cover attached, is defined in advance. As a condition for executing this operation, inclusion of a “report” is set as a condition that is necessarily required.

Further, the information processing apparatus 100 may set, as a condition for executing an operation on multiple objects, a condition required for each element constituting each object.

This is described below by way of specific example. As a condition for executing the report printing operation mentioned above, each of the following conditions may be set:

the authority to execute a “print” operation is provided for each individual document to be printed (the first condition is satisfied); and

for those documents whose document type is not “Other”, the “Disclosure Status” is “Public”.

The operation authority receiving module 105 is connected with the operation authority management module 110. The operation authority receiving module 105 issues an operation authority storage instruction 107 to the operation authority management module 110. The operation authority receiving module 105 receives, for each operation on an object group, a condition that enables execution of the operation (operation executing condition). The operation executing condition in this case includes a first condition associated with an object within an object group to which a target object is included, and a second condition for each element constituting the object. If the object is a document, examples of “each element constituting an object” include pages, chapters, sections, figures, and tables. If the object is a document group, examples of such an element include individual documents constituting the document group and, further, the elements constituting each document described above.

Examples of an operation executing condition (first condition) include the followings: (A1) a condition determined by the relation between an object and another object within an object group in which a target object is included, (A2) a condition determined by the state of an object to be created in a step within a task process, (A3) a condition determined by the state of another step associated with a step or the state of an object to be created in the other step, (A4) a condition determined by information related to a user who has made an operation request, and (A5) a condition determined by a target object. For example, the operation executing condition may include at least one of these conditions, such as the condition (A1). The operation executing condition (first condition) may include a combination of multiple conditions. Examples of such combinations include logical operations such as logical OR and logical AND.

Examples of the operation executing condition (second condition) may include (B1) a condition determined by the presence or absence of a specific element within an object, and (B2) a condition that requires an element (or an object in which the element is included) to satisfy the first condition. As another condition (B3), if an element is an object (document), the operation executing condition (second condition) may further include the first condition (each of the conditions (A1) to (A5)). Specifically, the operation executing condition (second condition) may include a condition related to the configuration information (specifically, a document configuration information table 500) about a document that serves as an element in this case. The operation executing condition (second condition) may include a combination of multiple conditions. Examples of such combinations include logical operations such as logical OR and logical AND. Further, the first and second conditions may be combined.

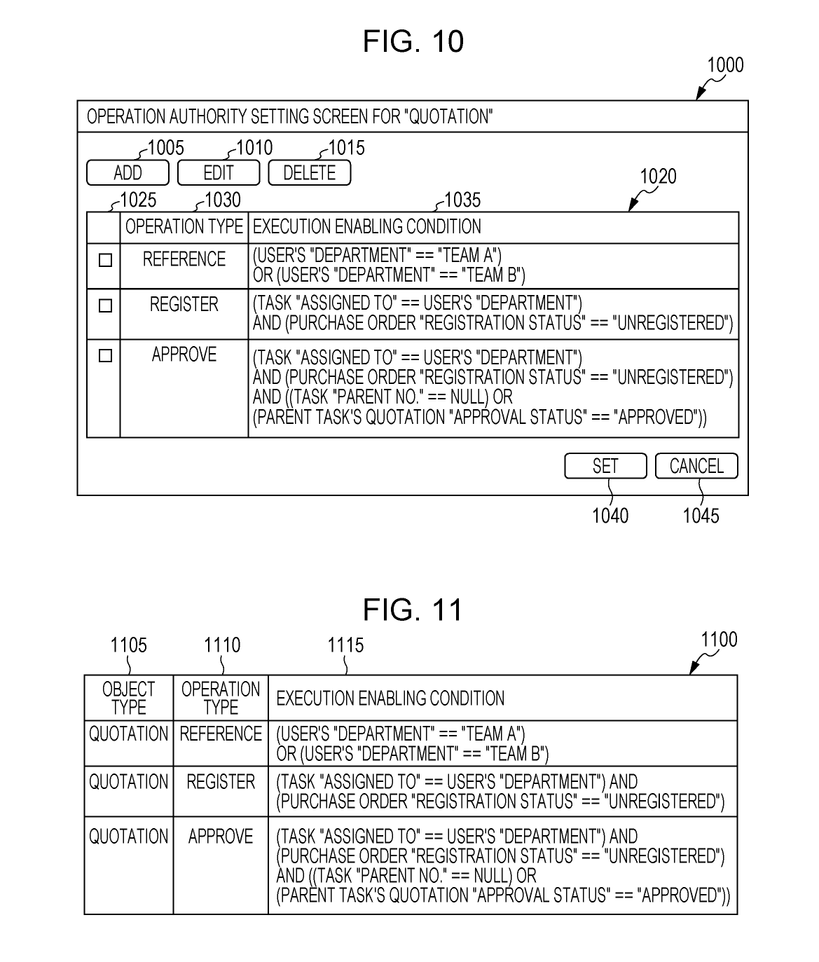

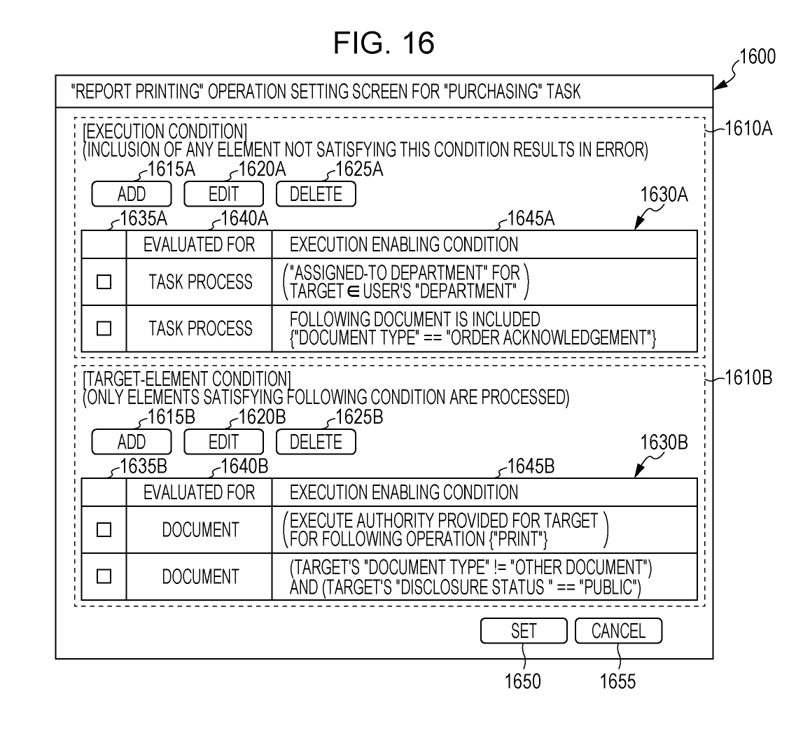

The function of the operation authority receiving module 105 and processing performed by the operation authority receiving module 105 will be described later with reference to FIGS. 10 and 16.

The operation authority management module 110 is connected with the operation authority receiving module 105 and the operation authority evaluating module 135. The operation authority management module 110 saves operation authority information input from the operation authority receiving module 105. In other words, the operation authority management module 110 stores an operation executing condition (the first condition and/or the second condition) associated with an object group in which a target object is included. The operation authority management module 110 passes the operation authority information in response to referencing of operation authority settings, which is indicated at 109, from the operation authority evaluating module 135.

The operation authority management module 110 sets the authority to execute an operation on an object, as a rule using a condition to be satisfied by each individual element. For example, a conditional expression using the state of an element, or the authority to execute another operation for an element may be set.

The operation authority management module 110 may be allowed to specify whether to enable execution of an operation if all elements satisfy a condition that is to be satisfied by each individual element, or enable the operation only for those elements which satisfy a condition that is to be satisfied by each individual element (or exclude those elements which do not satisfy such a condition).

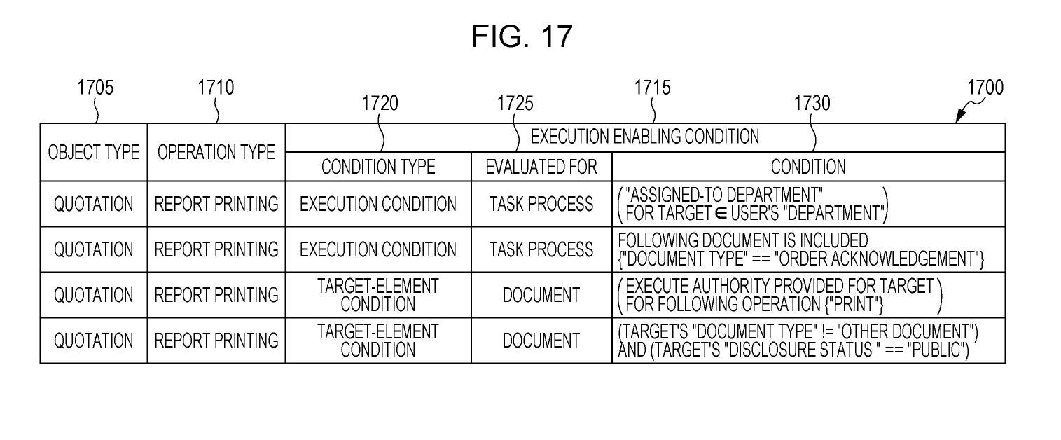

A condition that differs from each type of element may be set as an execution condition for an element. As will be described later with reference to FIG. 17, this may be accomplished by allowing multiple conditions to be specified for an element.

The authority to execute an operation on multiple objects may be set as a rule using a condition related to element configuration information (specifically, the document configuration information table 500). For example, a condition may be set such that the execution of the operation is conditioned on inclusion of a single application form as well as inclusion of multiple other documents. In this case, a rule for determining what kind of document constitutes an application form may be set at the same time. As will be described later with reference to FIG. 17, this rule is set as a condition that necessarily requires inclusion of a document whose document type is “Order Acknowledgement”.

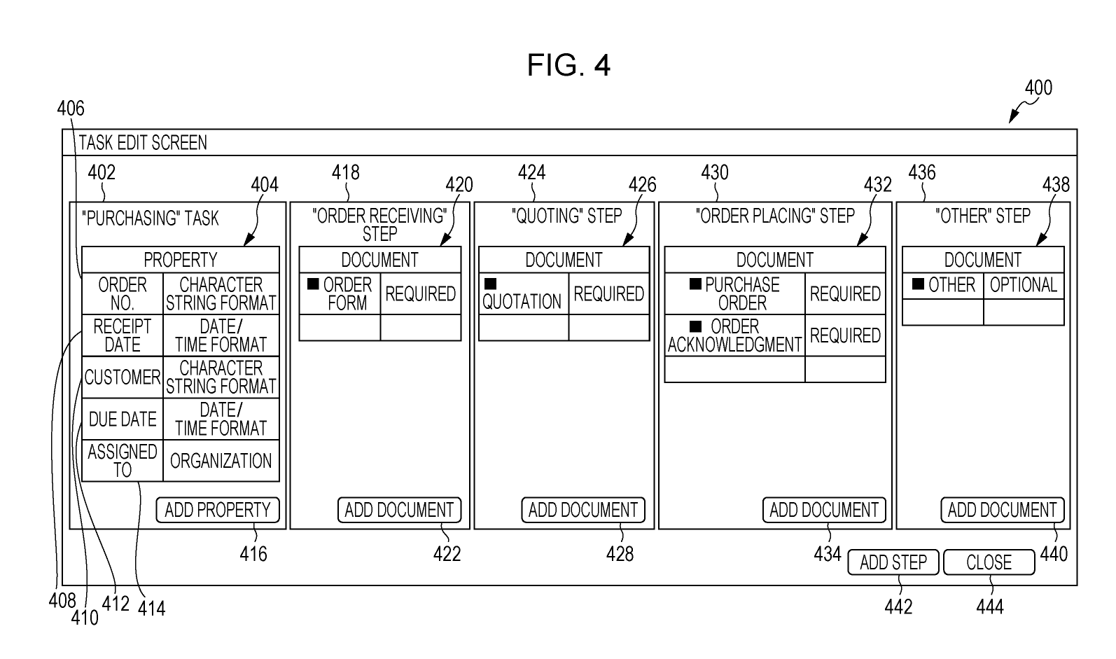

The configuration information receiving module 115 is connected with the configuration information management module 120. The configuration information receiving module 115 issues a configuration information storage instruction 117 to the configuration information management module 120. The configuration information receiving module 115 receives configuration information about an object group associated with a target object. Specifically, the configuration information receiving module 115 receives the relation between the structure of a task process and documents created in the course of (in each step within) the task process. The function of the configuration information receiving module 115 and processing performed by the configuration information receiving module 115 will be described later with reference to FIG. 4.

The configuration information management module 120 is connected with the configuration information receiving module 115 and the operation authority evaluating module 135. The configuration information management module 120 saves, in response to the configuration information storage instruction 117, configuration information about an object group associated with a target object. The configuration information management module 120 passes the configuration information in response to referencing of configuration information, which is indicated at 119, from the operation authority evaluating module 135.

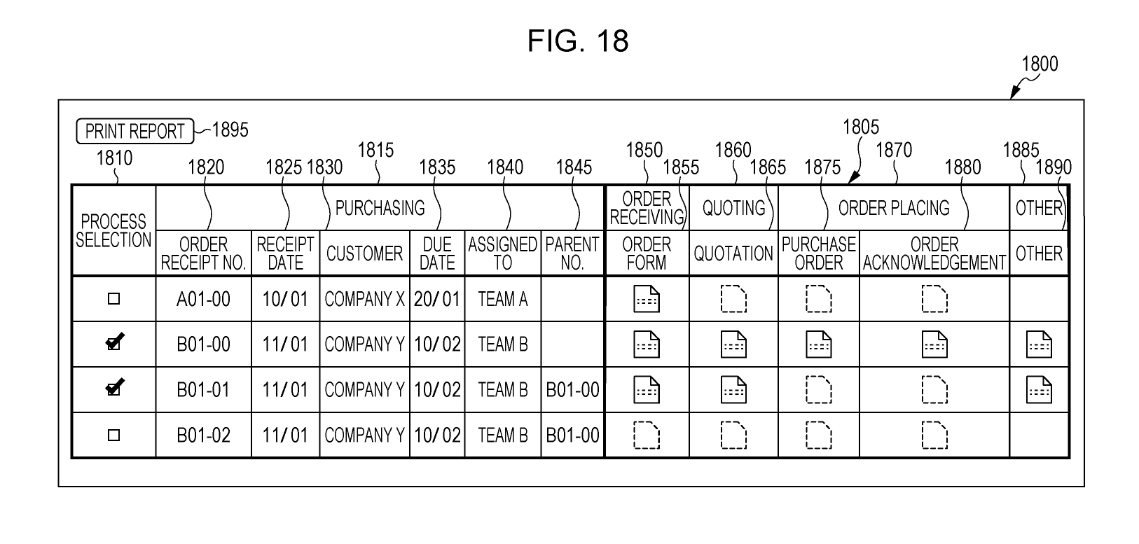

The operation instructing module 125 is connected with the operation executing module 130. The operation instructing module 125 receives an operation request for an object (a set of an operation to be executed and an object on which to execute the operation). Then, the operation instructing module 125 issues an operation instruction 127 according to the operation request to the operation executing module 130. The user instructs which operation is to be executed for what object, and the operation instructing module 125 receives this instruction. An example of such an instruction is an instruction to select, view (open), delete, or print a document. The operation instructing module 125 may receive, as the operation instruction 127, a batch operation for individual elements constituting an object. This will be described with greater specificity later with reference to FIG. 18 or other figures.

The operation executing module 130 is connected with the operation instructing module 125 and the operation authority evaluating module 135. The operation executing module 130 issues an operation authority evaluation instruction 132 to the operation authority evaluating module 135. Specifically, the operation executing module 130 receives the operation instruction 127 from the operation instructing module 125, and issues an instruction (the operation authority evaluation instruction 132) instructing the operation authority evaluating module 135 to evaluate whether an operation of interest is executable. The operation executing module 130 executes the operation for those elements for which the operation has been determined to be executable.

The operation authority evaluating module 135 includes a Condition-A evaluating module 135A, and a Condition-B evaluating module 135B. The operation authority evaluating module 135 is connected with the operation authority management module 110, the configuration information management module 120, the operation executing module 130, the user information management module 140, and the target object information management module 150.

In response to an instruction to execute an operation, the operation authority evaluating module 135 evaluates operation authority information (rule) set in association with the operation to thereby determine whether the operation is executable. In evaluating a rule, the operation authority evaluating module 135 refers to the state of each object in a target object group as required. The operation authority evaluating module 135 determines that the operation instructed to be executed is executable only if the evaluation result is true.

The operation authority evaluating module 135 (the Condition-A evaluating module 135A and/or the Condition-B evaluating module 135B) applies an operation executing condition to an object for which an operation has been requested to thereby determine whether to permit the operation on the object. The operation executing condition includes the first condition associated with an object in an object group in which the object is included, and the second condition for each element constituting the object. The operation authority evaluating module 135 may permit a batch operation for individual elements constituting the object. This will be described with greater specificity later with reference to FIG. 18 and other figures.

The operation authority evaluating module 135 performs the referencing of operation authority settings 109 with respect to the operation authority management module 110, performs the referencing of information reference 119 with respect to the configuration information management module 120, performs referencing of user information, which is indicated at 137, with respect to the user information management module 140, and performs referencing of object information, which is indicated at 147, with respect to the target object information management module 150. In other words, the operation authority evaluating module 135 receives the operation authority evaluation instruction 132 from the operation executing module 130, and refers to the settings information about the corresponding operation authority in the operation authority management module 110. The operation authority evaluating module 135 acquires necessary information from the user information management module 140, the target object information management module 150, the configuration information management module 120, and other modules, and evaluates the presence/absence of operation authority in accordance with the operation authority settings.

The Condition-A evaluating module 135A evaluates the first condition associated with an object.

The Condition-B evaluating module 135B evaluates the second condition for each element constituting the object.

The Condition-A evaluating module 135A applies, to an object for which an operation request has been made, an operation executing condition (first condition) associated with an object group in which the object is included to thereby determine whether to permit or deny an operation on the object. The operation executing condition (first condition) may include a condition determined by the relation between an object and another object within an object group in which the object is included.

The operation executing condition (first condition) may include a condition related to the state of an object to be created in a step within a task process.

The operation executing condition (first condition) may include a condition determined by the state of another step (A) related to a step or the state of an object to be created in the other step (A). Examples of “another step related to a step” in this case include a parent step if steps have a hierarchical structure. Examples of the “state of a step” include the presence/absence of the step.

The operation executing condition (first condition) may include a condition related to information about a user who has made the operation request.

The operation executing condition (first condition) may include a condition related to the object.

The Condition-A evaluating module 135A performs the above-mentioned determination process upon receipt of the operation authority evaluation instruction 132 from the operation executing module 130. Each of the above-mentioned operation executing conditions (first conditions) is acquired by performing, with respect to the operation authority management module 110, the referencing of operation authority settings 109 corresponding to the operation authority evaluation instruction 132. The referencing of operation authority settings 109 corresponding to the operation authority evaluation instruction 132 means extracting, based on a combination of an object group in which a target object is included and an operation, an operation executing condition (first condition) corresponding to the combination. Then, information required for application of the operation executing condition (first condition) to the object is acquired from at least one of the configuration information management module 120, the user information management module 140, and the target object information management module 150. At least configuration information from the configuration information management module 120 may be included in the information acquired at this time.

The Condition-B evaluating module 135B may be allowed to, if the first condition is satisfied, determine whether to permit an operation of interest to be executed for each element in accordance with the second condition.

The Condition-B evaluating module 135B may not permit an operation of interest to be executed for those elements which do not satisfy the second condition.

The user information management module 140 is connected with the operation authority evaluating module 135. The user information management module 140 manages user-related information, which represents information related to a user who has instructed an operation to be performed on an object. Specifically, the user information management module 140 manages information such as information related to each individual user, group information, and organization information. The operation authority evaluating module 135 passes the user-related information in response to the referencing of user information 137 made from the operation authority evaluating module 135.

The target object information management module 150 is connected with the operation authority evaluating module 135. The target object information management module 150 manages object-related information representing information related to an object that can be subject to an operation of interest. Examples of object-related information include document name, creator, date/time of creation, and document size. The target object information management module 150 passes the object-related information in response to the referencing of object information 147 made from the operation authority evaluating module 135.

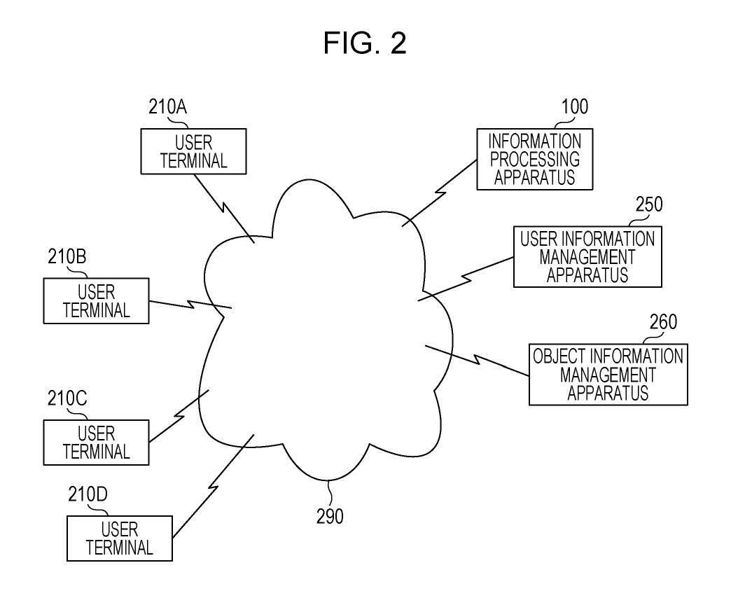

FIG. 2 illustrates an exemplary system configuration according to the exemplary embodiment.

The information processing apparatus 100, a user terminal 210A, a user terminal 210B, a user terminal 210C, a user terminal 210D, a user information management apparatus 250, and an object information management apparatus 260 are connected to each other via a communication line 290. The communication line 290 may be a wireless communication line, a wired communication line, or a combination thereof. For example, the communication line 290 may be the Internet or an intranet as a communication infrastructure. The functions provided by the information processing apparatus 100, the user information management apparatus 250, and the object information management apparatus 260 may be each implemented as a cloud service. Each of the user terminals 210A to 210D receives an operation to be performed on an object (an operation request made for the object) by the user, and requests the information processing apparatus 100 to execute the operation for the object. The information processing apparatus 100 determines, in accordance with an operation executing condition (first condition) associated with an object group in which the object is included, whether it is possible to execute the operation for the object. If the operation executing condition (first condition) is satisfied, the information processing apparatus 100 executes the operation, and if the operation executing condition (first condition) is not satisfied, the information processing apparatus 100 cancels the operation and issues a warning to that effect. The information processing apparatus 100 executes the operation for those elements which satisfy the operation executing condition (second condition). The information processing apparatus 100 does not execute the operation for those elements which do not satisfy the operation executing condition (second condition). In the latter case, the information processing apparatus 100 may issue a warning to that effect.

The user information management apparatus 250 provides the user information management module 140 with user-related information. The object information management apparatus 260 provides the target object information management module 150 with object-related information. The information processing apparatus 100 may include the user information management apparatus 250 and the object information management apparatus 260. In other words, the user information management apparatus 250 may serve as the user information management module 140, and the object information management apparatus 260 may serve as the target object information management module 150.

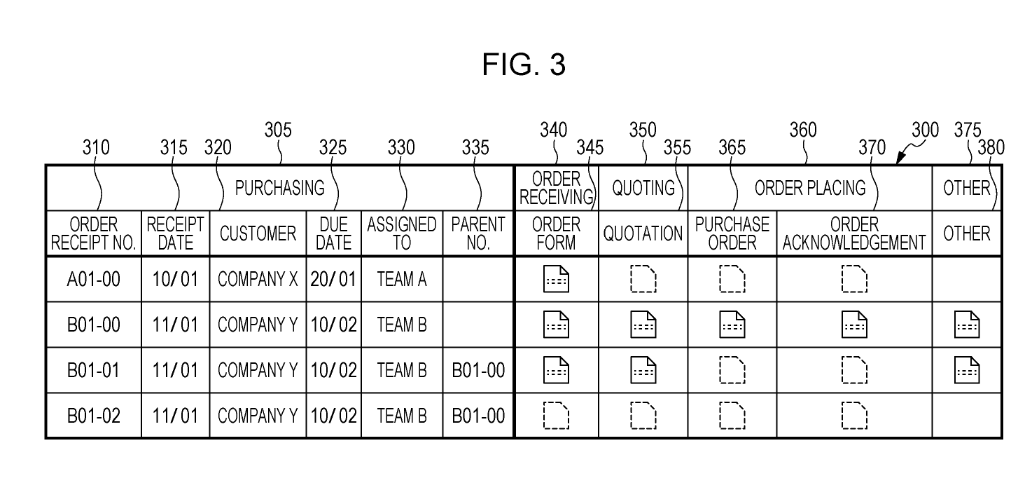

FIG. 3 illustrates exemplary information shown on a task list screen according to the exemplary embodiment.

A task list screen 300 shows information related to the structure of a task process stored in the configuration information management module 120. In other words, the task list screen 300 is a task list screen based on an application program that, based on the structure of a task process, enables checking of the registration status of documents generated in a task. The task list screen 300 provides at-a-glance view of the registration status of documents associated with a task. A given document may be referenced from the task list screen 300.

Copying or moving (drag-and-dropping (D&D)) a document to a given document cell on the task list screen 300 allows the document to be stored in association with a task process.

In response to a request for an operation such as the store operation mentioned above, a view operation (an operation of selecting a document icon within the task list screen 300 to open a document), or an edit operation for a document, it is determined in accordance with the operation executing condition (first condition) whether to permit the operation for the document. Then, in accordance with the operation executing condition (second condition), it is determined for each element within the document whether to permit the operation for the element.

The task list screen 300 has a Purchasing field 305, an Order Receiving field 340, a Quoting field 350, an Order Placing field 360, and an Other field 375. The Purchasing field 305 has an Order Receipt No. field 310, a Received Date field 315, a Customer field 320, a Due Date field 325, an Assigned To field 330, and a Parent No. field 335. The Order Receiving field 340 has an Order Form field 345, the Quoting field 350 has a Quotation field 355, the Order Placing field 360 has a Purchase Order field 365 and an Order Acknowledgement field 370, and the Other field 375 has an Other field 380.

The Purchasing field 305 shows information necessary for a purchasing task. The Order Receipt No. field 310 shows an order receipt number. The Received Date field 315 shows the date of order receipt. The Customer field 320 shows a customer. The Due Date field 325 shows a due date. The Assigned To field 330 shows the entity to which the task is assigned. The Parent No. field 335 shows a parent number. The fields from the Order Receiving field 340 onward each show the presence/absence of a document stored for the task. For example, if a document icon appears in the Order Form field 345 of the Order Receiving field 340, this indicates that an order form associated with the “Order Receiving” step has been created and stored in the document management system. The Order Receiving field 340 shows a document necessary for the “Order Receiving” step. The Order Form field 345 shows the presence or absence of an order form that has been stored. The Quoting field 350 shows a document necessary for the “Quoting” step. The Quotation field 355 shows the presence or absence of a quotation that has been stored. The Order Placing field 360 shows each document necessary for the “Order Placing” step. The Purchase Order field 365 shows the presence or absence of a purchase order that has been stored. The Order Acknowledgement field 370 shows the presence or absence of an order acknowledgement that has been stored. The Other field 375 and the Other field 380 each show information about another document.

For example, individual rows on the task list screen 300 show the following information. That is, the first row shows that for the task with the order receipt No.: “A01-00”, an order form associated with the order-receiving step has been stored. The second row shows that for the task with the order receipt No.: “B01-00”, an order form associated with the order-receiving step, a quotation associated with the quoting step, a purchase order and an order acknowledgement that are associated with the order-placing step, and another document have been stored. The third row shows that for the task with the order receipt No.: “B01-01”, an order form associated with the order-receiving step, a quotation associated with the quoting step, and another document have been stored. The fourth row shows that for the task with the order receipt No.: “B01-02”, there is no stored document.

FIG. 4 illustrates exemplary information shown on a task edit screen according to the exemplary embodiment (in particular, the configuration information receiving module 115). FIG. 4 depicts an exemplary screen for setting the relation between the structure of a task process and documents created in the course of task performance. The content of a task edit screen 400 specifies the content of the task list screen 300 illustrated in FIG. 3. In other words, the content of the task edit screen 400 corresponds to the definition of a class in an object-oriented system. Specifically, the task edit screen 400 defines the following items of information in association with each other: a task process made up of multiple steps, and the type of document that may be created in each individual step.

The task edit screen 400 shows a “Purchasing” task property setting region 402, an “Order Receiving” step document setting region 418, a “Quoting” step document setting region 424, an “Order Placing” step document setting region 430, an “Other” step document setting region 436, an Add Step button 442, and a Close button 444. The “Purchasing” task property setting region 402 specifies the structure (such as attributes) of the “Purchasing” task process, and regions such as the “Order Receiving” step document setting region 418 show individual steps within the “Purchasing” task process, as shown from the left in the order in which these steps occur.

The “Purchasing” task property setting region 402 has a Property setting region 404, and an Add Property button 416. The Property setting region 404 includes the following regions showing individual attributes: an Order No. setting region 406, a Received Date setting region 408, a Customer setting region 410, a Due Date setting region 412, and an Assigned To setting region 414. The Order No. setting region 406 shows that the “Order No.” is in “Character String Format”, the Received Date setting region 408 shows that the “Received Date” is in “Date/Time Format”, the Customer setting region 410 shows that the “Customer” is in “Character String Format”, the Due Date setting region 412 shows that the “Due Date” is in “Date/Time Format”, and the Assigned To setting region 414 shows that the entity to which the task is “Assigned To” is “Organization”. Selecting the Add Property button 416 allows an attribute to be added for the “Purchasing” task.

Regions such as the “Order Receiving” step document setting region 418 and the “Quoting” step document setting region 424 show that the “Purchasing” task process includes an “Order Receiving” step, a “Quoting” step, an “Order Placing” step, and an “Other” step.

The “Order Receiving” step document setting region 418 includes a Document setting region 420, and an Add Document button 422. The “Quoting” step document setting region 424 includes a Document setting region 426, and an Add Document button 428. The “Order Placing” step document setting region 430 includes a Document setting region 432, and an Add Document button 434. The “Other” step document setting region 436 includes a Document setting region 438, and an Add Document button 440.

The Document setting region 420 shows that for the “Order Receiving” step, an “Order Form” is “Required”. The Document setting region 426 shows that for the “Quoting” step, a “Quotation” is “Required”. The Document setting region 432 shows that for the “Order Placing” step, a “Purchase Order” and an “Order Acknowledgement” are “Required”. The Document setting region 438 shows that for the “Other” step, an “Other” document is “Optional”. Selecting a button such as the Add Document button 422 allows a document to be added for the corresponding step.

Selecting the Add Step button 442 allows a step to be added for the “Purchasing” task process. Selecting the Close button 444 causes the configuration information management module 120 to store, as the configuration information storage instruction 117, the relation between the structure of the “Purchasing” task process and documents created in the course of task performance within the task edit screen 400.

The “relation between the “Purchasing” task process and documents created in the course of task performance” actually generated based on the relation between the structure of the “Purchasing” task process and documents created in the course of task performance that is specified in FIG. 4 is represented as a document configuration information table 500. In other words, this corresponds to an instance generated based on a class in an object-oriented system. The document configuration information table 500 is stored in the configuration information management module 120.

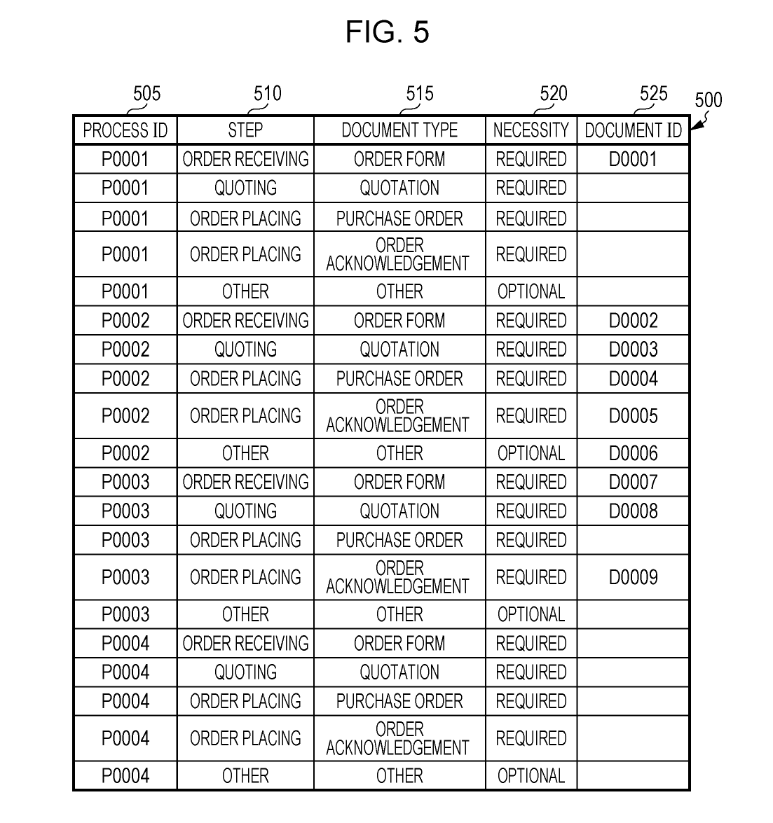

FIG. 5 illustrates an exemplary data structure of the document configuration information table 500. The document configuration information table 500 has a Process ID field 505, a Step field 510, a Document Type field 515, a Necessity field 520, and a Document ID field 525. The Process ID field 505 stores information (process identification (ID)) for uniquely identifying a task process according to the exemplary embodiment. The Step field 510 stores a step constituting the task process. The Document Type field 515 stores the type of each document (e.g., a name such as “Order Form”) created in the step. The Necessity field 520 stores the degree of necessity of the document for completion of the step (e.g., required or optional). The Document ID field 525 stores information (document ID) for uniquely identifying a document according to the exemplary embodiment. In other words, if a document ID is stored in the Document ID field 525, this means that a document has been stored in the step, and if the Necessity field 520 is “Required” and all of documents corresponding to the step have been stored, this means that the step has been completed.

In accordance with information on the first to fifth rows of the document configuration information table 500 (process ID: P0001), information on the first row of the task list screen 300 (order receipt No.: A01-00) is shown. In accordance with information on the sixth to tenth rows of the document configuration information table 500 (process ID: P0002), information on the second row of the task list screen 300 (order receipt No.: B01-00) is shown. In accordance with information on the eleventh to fifteenth rows of the document configuration information table 500 (process ID: P0003), information on the third row of the task list screen 300 (order receipt No.: B01-01) is shown. In accordance with information on the sixteenth to twentieth rows of the document configuration information table 500 (process ID: P0004), information on the fourth row of the task list screen 300 (order receipt No.: B01-02) is shown.

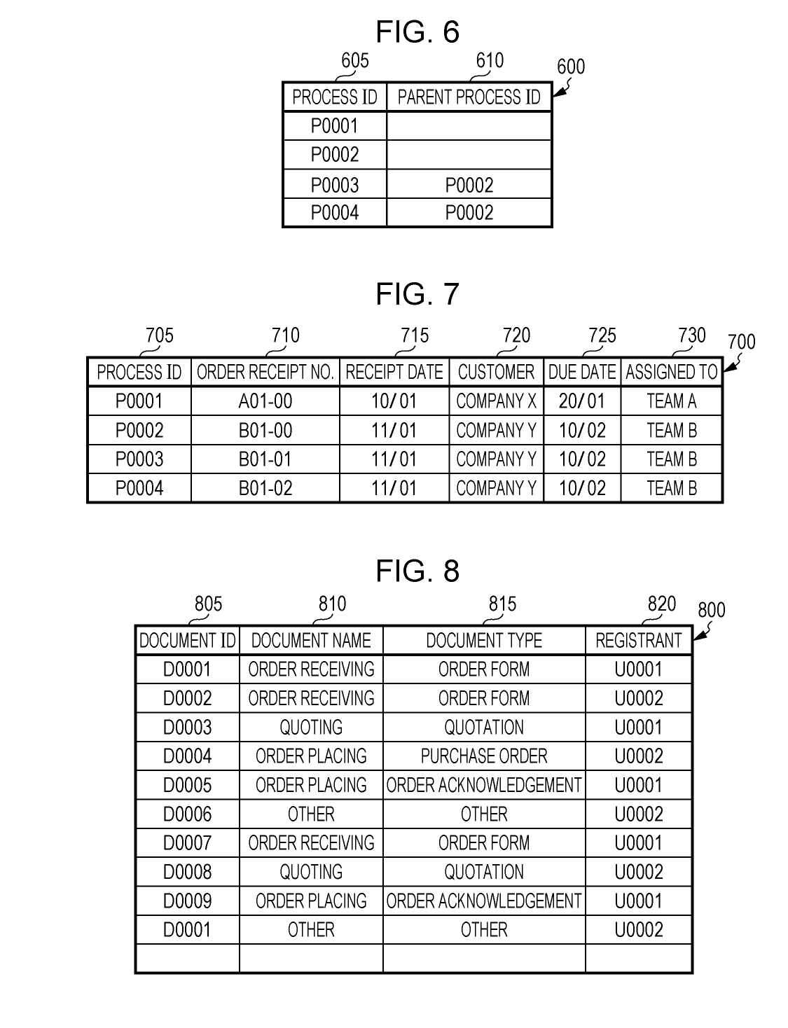

The relation between task processes is represented as a process configuration information table 600. The process configuration information table 600 is stored in the configuration information management module 120. FIG. 6 illustrates an exemplary data structure of the process configuration information table 600. The process configuration information table 600 includes a Process ID field 605, and a Parent Process ID field 610. The Process ID field 605 stores a process ID. The Parent Process ID field 610 stores a parent process ID. The presence of a parent process means that a process of interest has been generated based on the parent process. FIG. 6 illustrates that for processes with process IDs: “P0003” and “P0004”, a process with a process ID: “P0002” is the parent process. This parent process may be used to specify another step.

The “structure of the “Purchasing” task process” actually generated based on the relation between the structure of the “Purchasing” task process and documents created in the course of task performance that is specified in FIG. 4 is represented as a process information table 700. In other words, this corresponds to an instance generated based on a class in an object-oriented system. The process information table 700 is stored in the configuration information management module 120.

FIG. 7 illustrates an exemplary data structure of the process information table 700. The process information table 700 includes a Process ID field 705, an Order Receipt No. field 710, a Received Date field 715, a Customer field 720, a Due Date field 725, and an Assigned To field 730. The Process ID field 705 stores a process ID. The Order Receipt No. field 710 stores the order receipt number of the corresponding task process. The Received Date field 715 stores the date of receipt of the task process. The Customer field 720 stores the customer for the task process. The Due Date field 725 stores the due date for the task process. The Assigned To field 730 stores the organization (e.g., team) to which the task process is assigned.

The Purchasing field 305 on the task list screen 300 illustrated in FIG. 3 represents the process information table 700 and the process configuration information table 600.

FIG. 8 illustrates an exemplary data structure of a document information table 800. The document information table 800 is stored in the target object information management module 150. The document information table 800 includes a Document ID field 805, a Document Name field 810, a Document Type field 815, and a Registrant field 820. The Document ID field 805 stores a document ID. The Document Name field 810 stores a document name. The Document Type field 815 stores the type of a document of interest. The Registrant field 820 stores the user who has registered the document. In response to an operation made on the task edit screen 400 illustrated in FIG. 4 to store a document, the registrant is stored into the Registrant field 820.

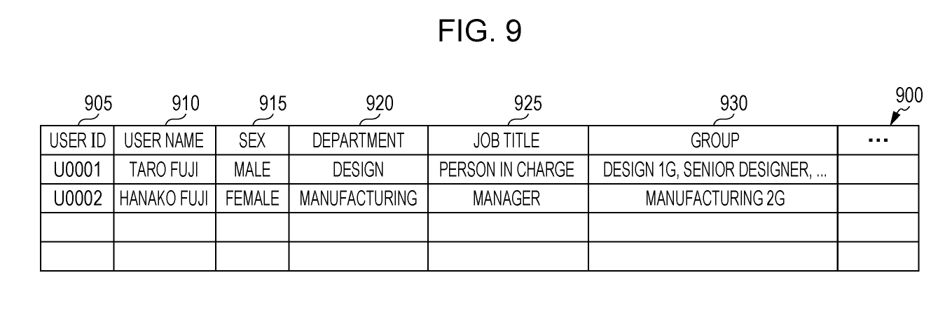

FIG. 9 illustrates an exemplary data structure of a user information table 900. The user information table 900 is stored in the user information management module 140. The user information table 900 includes a User ID field 905, a User Name field 910, a Sex field 915, a Department field 920, a Job Title field 925, and a Group field 930. The User ID field 905 stores information (user ID) for uniquely identifying a user according to the exemplary embodiment. The User Name field 910 stores the name of the user. The Sex field 915 stores the sex of the user. The Department field 920 stores the department to which the user belongs. The Job Title field 925 stores the job title of the user. The Group field 930 stores the group to which the user belongs.

FIG. 10 illustrates exemplary information shown on a document-group operation authority setting screen 1000 according to the exemplary embodiment (in particular, the operation authority receiving module 105). FIGS. 10 to 15 illustrate a case where only the first condition is used as an execution enabling condition (operation executing condition).

The document-group operation authority setting screen 1000 shows an Add button 1005, an Edit button 1010, a Delete button 1015, an operation authority setting region 1020, a Set button 1040, and a Cancel button 1045.

The operation authority setting region 1020 includes a check field 1025, an Operation Type field 1030, and an Execution Enabling Condition field 1035. The check field 1025 shows a check field. The Operation Type field 1030 shows an operation type. The Execution Enabling Condition field 1035 shows an execution enabling condition (operation executing condition (first condition)).

Selecting the Add button 1005 allows an operation executing condition (first condition) to be added to the operation authority setting region 1020. Selecting the Edit button 1010 allows a row checked in the check field 1025 to be edited. Selecting the Delete button 1015 allows a row checked in the check field 1025 to be deleted.

The document-group operation authority setting screen 1000 is a screen for specifying an operation executing condition (first condition) for a “Quotation” representing an object group.

The first row of the operation authority setting region 1020 shows that to execute the operation type: reference, the following condition needs to be satisfied: “(user's “Department”==“Team A”) OR (user's “Department”==“Team B”)”. The second row of the operation authority setting region 1020 shows that to execute the operation type: register, the following condition needs to be satisfied: “(task “Assigned To”==user's “Department”) AND (purchase order “Registration Status”==“Unregistered”)”. The third row of the operation authority setting region 1020 shows that to execute the operation type: approve, the following condition needs to be satisfied: “(task “Assigned To”==user's “Department”) AND (purchase order “Registration Status”==“Unregistered”) AND ((task “Parent Number”==null) OR (patent task's quotation “Approval Status”==“Approved”))”.

In particular, the second and third rows each include a condition specified by the relation between a “Quotation”, which is a target object, and another document. In other words, the second row shows that a register operation for a “Quotation”, which is a target object, is enabled if the “Assigned To” attribute of a task including the “Quotation” and the “Department” attribute of the user attempting to use the “Quotation” are equal, and if the “Registration Status” of a “Purchase Order” document for the task process is “Unregistered”. The third row shows that an approve operation is enabled if the “Assigned To” attribute of a task including a “Quotation”, which is a target object, and the “Department” attribute of the user attempting to use the “Quotation” are equal, if the “Registration Status” of a “Purchase Order” document for the task process is “Unregistered”, and if no parent task exists or the “Approval Status” of a “Quotation” document for a parent task is “Approved”.

An example of a condition related to the state of an object to be created in a step within a task process is “Purchase Order “Registration Status”==“Unregistered””, which is related to the state of a purchase order in a task process including a quotation.

An example of a condition determined by the state of another step associated with a step of interest, or an example of a condition determined by the state of an object to be created in the other step is “parent task's quotation “Approval Status”==“Approved””, which is related to the state of a quotation for a parent task (including the state of a quoting step).

An example of a condition related to a user who has made an operation request is “task “Assigned To”==user's “Department””, which is related to the department to which the user belongs.

An example of an object-related condition is “task “Assigned To”==user's “Department””, which is related to the entity to which the quotation is assigned.

The operation executing condition (first condition) generated by using the document-group operation authority setting screen 1000 illustrated in FIG. 10 is stored as an operation authority table 1100.

FIG. 11 illustrates an exemplary data structure of the operation authority table 1100. The operation authority table 1100 is stored in the operation authority management module 110. The operation authority table 1100 in this case represents a state when the Set button 1040 has been selected on the document-group operation authority setting screen 1000 illustrated in FIG. 10.

The operation authority table 1100 includes an Object Type field 1105, an Operation Type field 1110, and an Execution Enabling Condition field 1115. The Object Type field 1105 stores an object type. The Operation Type field 1110 stores the type of an operation to be performed on an object corresponding to the object type. The Execution Enabling Condition field 1115 stores a condition for executing the operation corresponding to the operation type for the object.

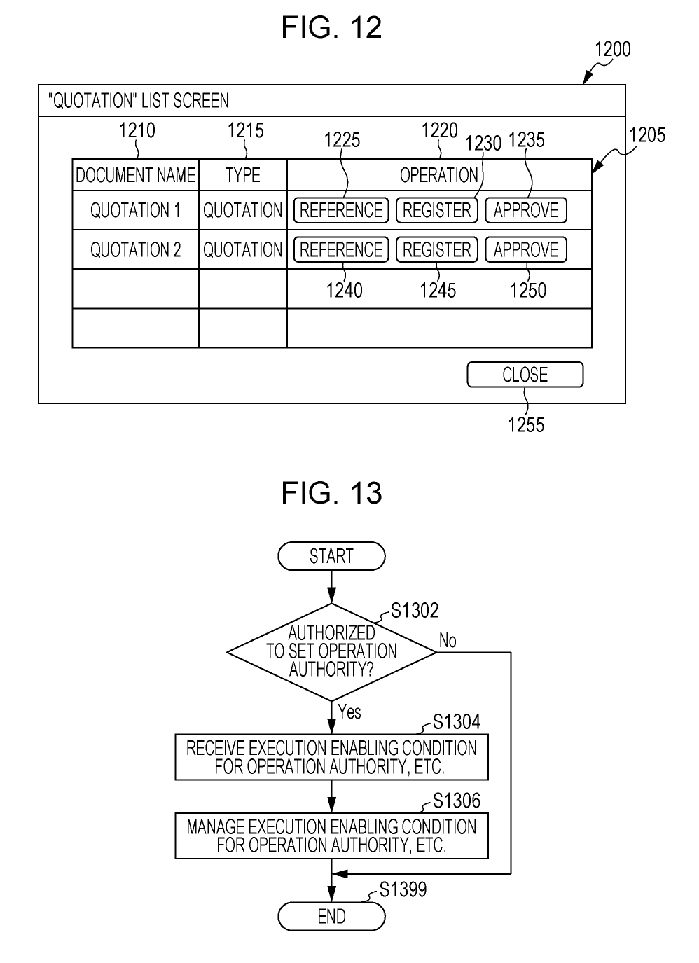

FIG. 12 illustrates exemplary information shown on a “Quotation” list screen 1200 according to the exemplary embodiment. The “Quotation” list screen 1200 is a screen used to perform operations on a quotation, including reference, register, and approve operations. The “Quotation” list screen 1200 shows an operation instructing region 1205, and a Close button 1255. The operation instructing region 1205 includes a Document Name field 1210, a Type field 1215, and an Operation field 1220. The Document Name field 1210 stores the name of a document of interest. The Type field 1215 shows the type of the document (an example of “a document group in which the document is included”). The Operation field 1220 shows each operation for the document. In the first row of the operation instructing region 1205, a Reference button 1225, a Register button 1230, and an Approve button 1235 are shown in a selectable manner for “Quotation 1”. In the second row of the operation instructing region 1205, a Reference button 1240, a Register button 1245, and an Approve button 1250 are shown in a selectable manner for “Quotation 2”.

FIG. 13 is a flowchart of an exemplary process according to the exemplary embodiment. This flowchart illustrates an exemplary process in which the document-group operation authority setting screen 1000 illustrated in FIG. 10 is used to generate the operation authority table 1100 illustrated in FIG. 11.

At step S1302, the operation authority receiving module 105 determines whether the user is authorized to set operation authority. If the determination is affirmative, the process proceeds to step S1304. Otherwise, the process is ended (step S1399). In other words, the operation authority receiving module 105 determines whether the user is an administrator authorized to generate, edit, delete, or perform other operations on the operation executing condition (first condition). For example, this may be determined by using the user ID or other information about the user.

At step S1304, the operation authority receiving module 105 receives information such as an execution enabling condition for the operation authority. Specifically, such information is received by use of the document-group operation authority setting screen 1000 illustrated in FIG. 10.

At step S1306, the operation authority management module 110 manages information such as the execution enabling condition for the operation authority. Specifically, the operation authority table 1100 illustrated in FIG. 11 is stored.

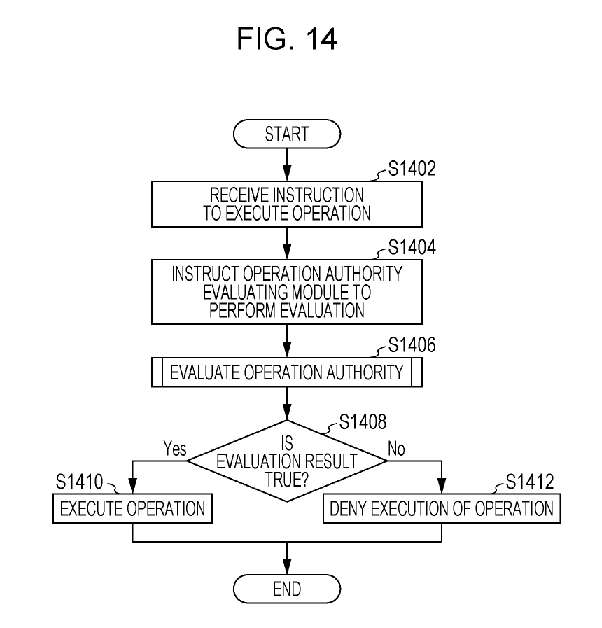

FIG. 14 is a flowchart of an exemplary process according to the exemplary embodiment.

At step S1402, the operation instructing module 125 receives an instruction to execute an operation. Specifically, this instruction is received by use of the “Quotation” list screen 1200 illustrated in FIG. 12.

At step S1404, the operation executing module 130 instructs the operation authority evaluating module 135 to perform an evaluation.

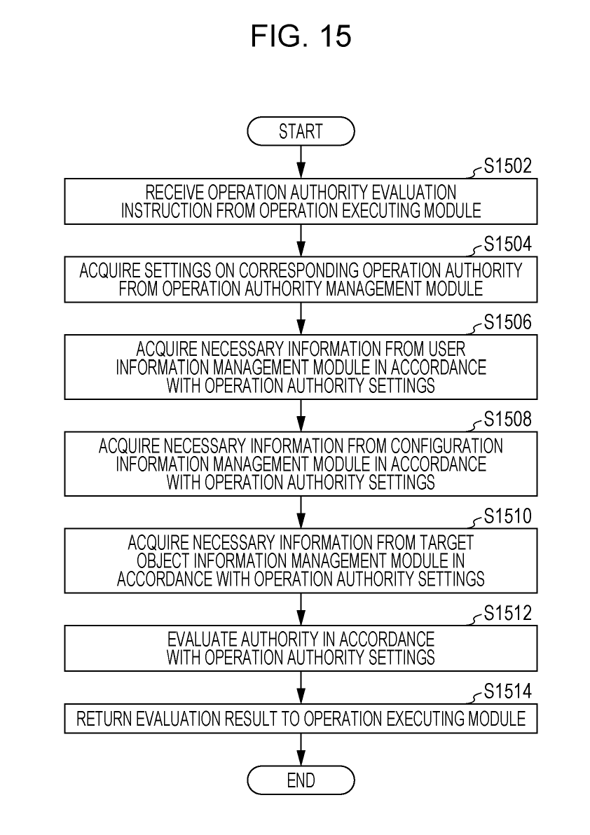

At step S1406, the operation authority evaluating module 135 (the Condition-A evaluating module 135A) performs an operation authority evaluation. Step S1406 will be described in detail later with reference to the flowchart illustrated in FIG. 15.

At step S1408, the operation authority evaluating module 135 (the Condition-A evaluating module 135A) determines whether the evaluation result is true. If the evaluation result is true (if the operation on the object is to be permitted), the process proceeds to step S1410. Otherwise, the process proceeds to step S1412.

At step S1410, the operation executing module 130 executes the operation.

At step S1412, the operation executing module 130 denies execution of the operation.

FIG. 15 is a flowchart illustrating an exemplary process according to the exemplary embodiment (in particular, the operation authority evaluating module 135 (the Condition-A evaluating module 135A)).

At step S1502, an operation authority evaluation instruction is received from the operation executing module 130.

At step S1504, the settings on the corresponding operation authority are acquired from the operation authority management module 110. Specifically, the operation executing condition (first condition) corresponding to the type of a target object is acquired from the operation authority table 1100.

At step S1506, in accordance with the operation authority settings, necessary information is acquired from the user information management module 140. Specifically, information necessary for evaluating the operation executing condition (first condition) is extracted from the user information table 900 within the user information management module 140.

At step S1508, in accordance with the operation authority settings, necessary information is acquired from the configuration information management module 120. Specifically, information necessary for evaluating the operation executing condition (first condition) is extracted from the document configuration information table 500, the process configuration information table 600, and the process information table 700 within the configuration information management module 120.

At step S1510, in accordance with the operation authority settings, necessary information is acquired from the target object information management module 150. Specifically, information necessary for evaluating the operation executing condition (first condition) is extracted from the document information table 800 within the target object information management module 150.

At step S1512, authority is evaluated in accordance with the operation authority settings. Specifically, the pieces of information acquired from steps S1506 to S1510 are applied to the operation executing condition (first condition) acquired in step S1504 to determine whether the operation executing condition (first condition) is satisfied.

At step S1514, the evaluation result is returned to the operation executing module 130.

FIG. 16 illustrates exemplary information shown on a “Report Printing” operation setting screen for “Purchasing” task 1600 according to the exemplary embodiment (in particular, the operation authority receiving module 105). FIGS. 16 to 20B illustrate a case in which each of the first and second conditions is used as the execution enabling condition (operation executing condition).

The “Report Printing” operation setting screen for “Purchasing” task 1600 shows an Execution Condition setting region 1610A for setting the first condition, a Target-Element Condition setting region 1610B for setting the second condition, a Set button 1650, and a Cancel button 1655.

The Execution Condition setting region 1610A shows an Add button 1615A, an Edit button 1620A, a Delete button 1625A, and an operation authority setting region 1630A.

The operation authority setting region 1630A includes a check field 1635A, an Evaluated For field 1640A, and an Execution Enabling Condition field 1645A. The check field 1635A shows a check field. The Evaluated For field 1640A shows what is being evaluated for the corresponding condition. The Execution Enabling Condition field 1645A shows an execution enabling condition (operation executing condition (first condition)).

Selecting the Add button 1615A allows an operation executing condition (first condition) to be added to the operation authority setting region 1630A. Selecting the Edit button 1620A allows a row checked in the check field 1635A to be edited. Selecting the Delete button 1625A allows a row checked in the check field 1635A to be deleted.

The Target-Element Condition setting region 1610B shows an Add button 1615B, an Edit button 1620B, a Delete button 1625B, and an operation authority setting region 1630B.

The operation authority setting region 1630B includes a check field 1635B, an Evaluated For field 1640B, and an Execution Enabling Condition field 1645B. The check field 1635B shows a check field. The Evaluated For field 1640B shows what is being evaluated for the corresponding condition. The Execution Enabling Condition field 1645B shows an execution enabling condition (operation executing condition (second condition)).

Selecting the Add button 1615B allows an operation executing condition (second condition) to be added to the operation authority setting region 1630B. Selecting the Edit button 1620B allows a row checked in the check field 1635B to be edited. Selecting the Delete button 1625B allows a row checked in the check field 1635B to be deleted.

The “Report Printing” operation setting screen for “Purchasing” task 1600 is a screen for specifying the operation executing condition (each of the first and second conditions) for a “Report Printing” operation in a “Purchasing” task. Specifically, the “Report Printing” operation setting screen for “Purchasing” task 1600 represents exemplary definition of execute authority for an operation that prints multiple documents included in a task of interest as batch processing on a per task process basis.

This operation is executable if the corresponding execution condition is satisfied. Further, only those elements (documents) which satisfy the corresponding target-element condition specifying for which element the operation is executable, are printed by this operation. Any element not satisfying this condition is excluded (not processed).

This operation is executable if the “Assigned-To Department” to which the task of interest is assigned includes the user's “Department”, and if a document whose “Document Type” is “Order Acknowledgement” is included as a document representing an element of the task of interest.

Only those documents for which “Print” authority has been provided are subject to this operation. Further, for those documents whose “Document Type” is not “Other”, such a document is subject to this operation only if its “Disclosure Status” is “Public”.

It is assumed that the “Print” operation authority is set individually for each element (document). However, the “Report Printing” operation authority is not set for each individual document.

The first row of the operation authority setting region 1630A, which specifies the first condition as an execution condition, shows that a task process is being evaluated, and the following condition needs to be satisfied for the task process: “(“Assigned-To Department” for the target∈user's “Department”)”. The second row of the operation authority setting region 1630A shows that a task process is being evaluated, and that the following condition needs to be satisfied: within the task process, “the following document is included {“Document Type”==“Order Acknowledgement”}”. The presence of any element that does not satisfy the condition described in each of the first and second rows of the Execution Enabling Condition field 1645A results in an error (the operation is not permitted).

The first row of the operation authority setting region 1630B, which specifies the second condition as a target-element condition, shows that a document is being evaluated, and the following condition needs to be satisfied for the document: “(execute authority is provided for the target for the following operation {“Print”})”. The second row of the operation authority setting region 1630B shows that a document is being evaluated, and the following condition needs to be satisfied for the document “(target's “Document Type”!=“Other”) AND (target's “Disclosure Status”==“Public”)”. Only those elements which satisfy the condition described in each of the first and second rows of the Execution Enabling Condition field 1645B are subject to an operation of interest.

The operation executing condition (each of the first and second conditions) generated by use of the “Report Printing” operation setting screen for “Purchasing” task 1600 illustrated in FIG. 16 is stored as an operation authority table 1700.

FIG. 17 illustrates an exemplary data structure of the operation authority table 1700. The operation authority table 1700 is stored in the operation authority management module 110. The operation authority table 1700 in this case represents a state when the Set button 1650 has been selected on the “Report Printing” operation setting screen for “Purchasing” task 1600 illustrated in FIG. 16.

The operation authority table 1700 includes an Object Type field 1705, an Operation Type field 1710, and an Execution Enabling Condition field 1715. The Execution Enabling Condition field 1715 includes a Condition Type field 1720, an Evaluated For field 1725, and a Condition field 1730. The Object Type field 1705 stores an object type. An example of an object type is a “Quotation” representing an object group. The Operation Type field 1710 stores an operation type. An example of an operation type is “Report Printing” specified in advance. The Execution Enabling Condition field 1715 stores an execution enabling condition required for performing the operation shown in the Object Type field 1705. The Condition Type field 1720 stores a condition type (either the execution condition (first condition) or target-element condition (second condition)). The Evaluated For field 1725 stores what is being evaluated for the corresponding condition. In this case, a task process is set to be evaluated for the execution condition (first condition), and a document is set to be evaluated for the target-element condition (second condition). The Condition field 1730 stores a condition. This represents a condition that the entity shown in the Evaluated For field 1725 is required to satisfy for the user to perform the operation shown in the Operation Type field 1710. If the Condition Type field 1720 indicates target-element condition (second condition), this represents a condition for specifying which element is subject to the operation. In other words, the operation “Report Printing” is performed for an element (document) satisfying this condition.

FIG. 18 illustrates exemplary information shown on a “Task Process” list screen 1800 according to the exemplary embodiment. In this case, each “Task Process” corresponds to “Object”, and each document associated with this task process corresponds to “Element”. The “Task Process” list screen 1800 provides at-a-glance view of the registration status of documents associated with each task process. A given document can be viewed from this screen. Drag-and-dropping a document to a given cell on this screen allows the document to be stored in association with a task process. Further, the “Task Process” list screen 1800 allows a given process to be selected to instruct that an operation such as “Report Printing” be performed as batch processing for each document associated with the selected process. In other words, a task process of interest is selected from multiple task processes being displayed, and upon detection of a click on the “Print Report” button, the first condition is elevated on a per task process basis, and the second condition is evaluated for each document representing an element of the task process that satisfies the first condition. Then, only those documents which satisfy the second condition are printed.

Specifically, the “Task Process” list screen 1800 shows a task list screen 1805, and a Print Report button 1895. The task list screen 1805 has a Process Selection field 1810, a Purchasing field 1815, an Order Receiving field 1850, a Quoting field 1860, an Order Placing field 1870, and an Other field 1885. The Purchasing field 1815 has an Order Receipt No. field 1820, a Received Date field 1825, a Customer field 1830, a Due Date field 1835, an Assigned To field 1840, and a Parent No. field 1845. The Order Receiving field 1850 has an Order Form field 1855, the Quoting field 1860 has a Quotation field 1865, the Order Placing field 1870 has a Purchase Order field 1875 and an Order Acknowledgement field 1880, and the Other field 1885 has an Other field 1890.

The Process Selection field 1810 shows a check field for allowing the user to select a task process in the corresponding row. When this check is selected, an operation of interest is performed for all of documents included in the task process corresponding to the checked row. When the Print Report button 1895 is selected, Report Printing is executed as batch processing for all of documents included in the task process corresponding to the checked row. The fields from the Purchasing field 1815 to the Other field 1890 are equivalent to the fields from the Purchasing field 305 to the Other field 375 within the task list screen 300 illustrated in FIG. 3. In other words, the Purchasing field 1815 shows information necessary for a purchasing task. The Order Receipt No. field 1820 shows an order receipt number. The Received Date field 1825 shows the date of order receipt. The Customer field 1830 shows a customer. The Due Date field 1835 shows a due date. The Assigned To field 1840 shows the entity to which the task is assigned. The Parent No. field 1845 shows a parent number. The fields from the Order Receiving field 1850 onward each show the presence/absence of a document stored for the task. For example, if a document icon appears in the Order Form field 1855 of the Order Receiving field 1850, this indicates that an order form associated with the “Order Receiving” step has been created and stored in the document management system. The Order Receiving field 1850 shows a document necessary for the “Order Receiving” step. The Order Form field 1855 shows whether an order form has been stored. The Quoting field 1860 shows a document necessary for the “Quoting” step. The Quotation field 1865 shows the presence or absence of a quotation that has been stored. The Order Placing field 1870 shows each document necessary for the “Order Placing” step. The Purchase Order field 1875 shows the presence or absence of a purchase order that has been stored. The Order Acknowledgement field 1880 shows the presence or absence of an order acknowledgement that has been stored. The Other field 1885 and the Other field 1890 each show information about another document.

As for an exemplary process in which the “Report Printing” operation setting screen for “Purchasing” task 1600 illustrated in FIG. 16 is used to generate the operation authority table 1700 illustrated in FIG. 17, a process equivalent to that of the flowchart illustrated in FIG. 13 may be performed.

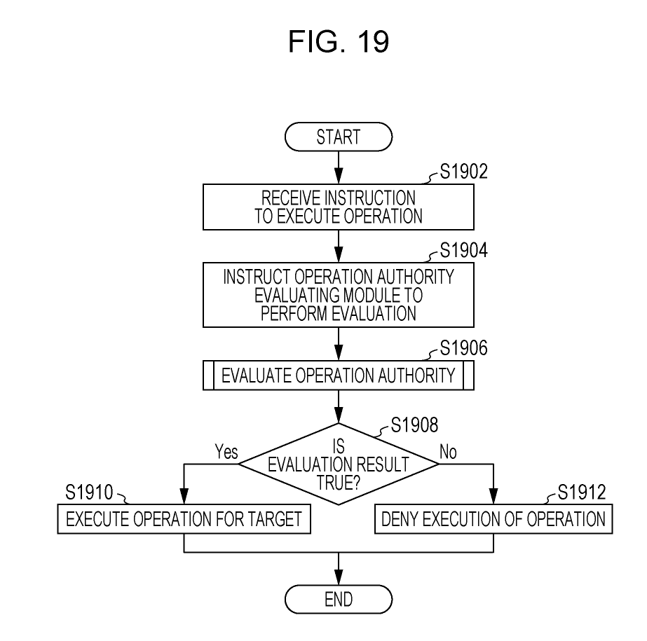

FIG. 19 is a flowchart of an exemplary process according to the exemplary embodiment.

At step S1902, the operation instructing module 125 receives an instruction to execute an operation. Specifically, this instruction is received by use of the “Task Process” list screen 1800 illustrated in FIG. 18. The instruction to execute an operation in this case corresponds to selection of the Print Report button 1895 after a check is placed in the Process Selection field 1810.

At step S1904, the operation executing module 130 instructs the operation authority evaluating module 135 to perform an evaluation.

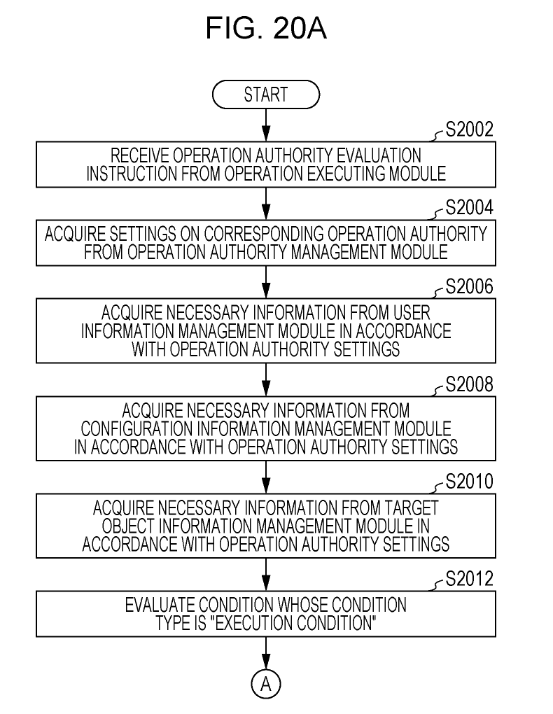

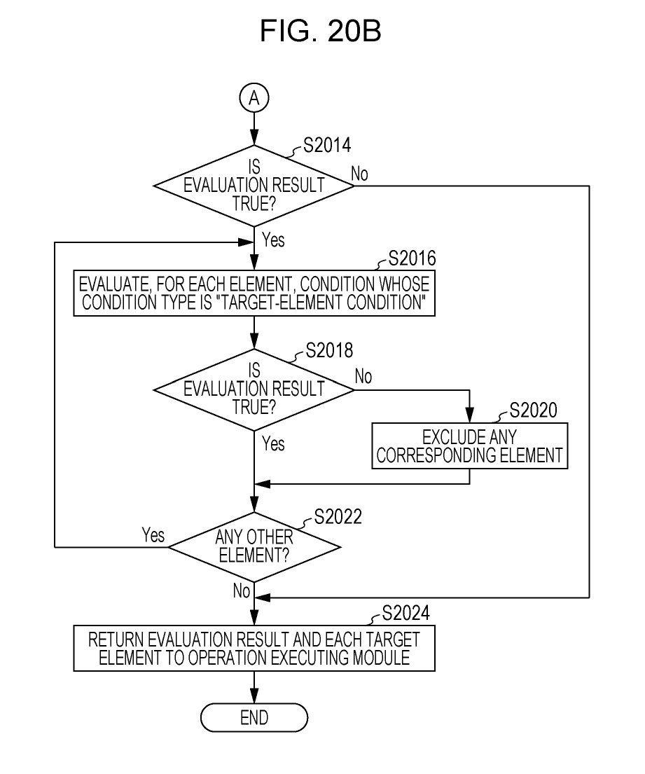

At step S1906, the operation authority evaluating module 135 (each of the Condition-A evaluating module 135A and the Condition-B evaluating module 135B) performs an operation authority evaluation. Step S1906 will be described in detail later with reference to the flowchart illustrated in FIGS. 20A and 20B.

At step S1908, the operation authority evaluating module 135 determines whether the evaluation result is true. If the evaluation result is true (if the operation on the object is to be permitted), the process proceeds to step S1910. Otherwise, the process proceeds to step S1912.

At step S1910, the operation executing module 130 executes the operation for a target element (an element (including an object) that satisfies the second condition).

At step S1912, the operation executing module 130 denies execution of the operation.

FIGS. 20A and 20B are flowcharts illustrating an exemplary process according to the exemplary embodiment (in particular, the operation authority evaluating module 135 (each of the Condition-A evaluating module 135A and the Condition-B evaluating module 135B)).

At step S2002, an operation authority evaluation instruction is received from the operation executing module 130.

At step S2004, the settings on the corresponding operation authority are acquired from the operation authority management module 110. Specifically, the operation executing condition (each of the first and second conditions) corresponding to the type of a target object is acquired from the operation authority table 1700.

At step S2006, in accordance with the operation authority settings, necessary information is acquired from the user information management module 140. Specifically, information necessary for evaluating the operation executing condition (each of the first and second conditions) is extracted from the user information table 900 within the user information management module 140.

At step S2008, in accordance with the operation authority settings, necessary information is acquired from the configuration information management module 120. Specifically, information necessary for evaluating the operation executing condition (each of the first and second conditions) is extracted from the document configuration information table 500, the process configuration information table 600, and the process information table 700 within the configuration information management module 120.

At step S2010, in accordance with the operation authority settings, necessary information is acquired from the target object information management module 150. Specifically, information necessary for evaluating the operation executing condition (each of the first and second conditions) is extracted from the document information table 800 within the target object information management module 150.

At step S2012, a condition whose condition type is “Execution Condition” (first condition) is evaluated. Specifically, the pieces of information acquired from steps S2006 to S2010 are applied to the execution condition (first condition) acquired in step S2004 to determine whether the execution condition (first condition) is satisfied.

At step S2014, it is determined whether the evaluation result at step S2012 is true, and if the evaluation result is true (if it is possible to execute an operation), the processing proceeds to step S2016. Otherwise, the process proceeds to step S2024. Steps from step S2016 onward are performed to identify which element is subject to an operation of interest. If the evaluation result is determined to be true at step S2014, the operation is performed for all of elements within a target object.

At step S2016, a condition whose condition type is “Target-Element Condition” (second condition) is evaluated for each element. Specifically, the pieces of information acquired from steps S2006 to S2010 are applied to the target-element condition (second condition) acquired in step S2004 to determine whether the target-element condition (second condition) is satisfied.

At step S2018, it is determined whether the evaluation result is true. The process proceeds to step S2022 if the evaluation result is true. Otherwise, the process proceeds to step S2020.

At step S2020, any corresponding element is excluded.

At step S2022, it is determined whether there is any other element within a target object. If there is any other element, the process returns to step S2016. Otherwise, the process proceeds to step S2024.

At step S2024, the evaluation result (the evaluation result at step S2012) and each target element (element subject to the operation of interest) are returned to the operation executing module 130.

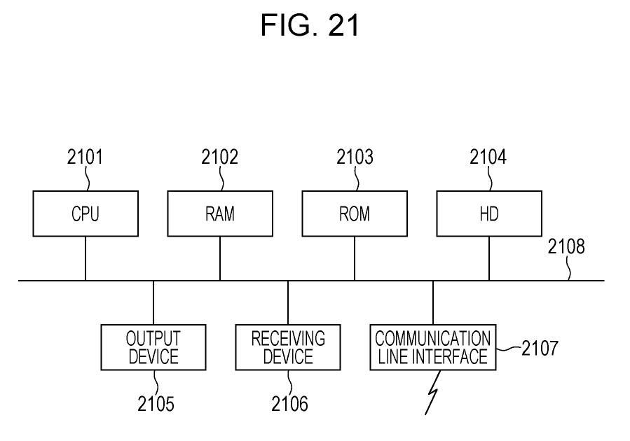

The hardware configuration of a computer on which the program according to the exemplary embodiment is executed is that of a general computer as illustrated in FIG. 21, specifically, for example, a personal computer, or a computer that can serve as a server. That is, as a specific example, a CPU 2101 is used as a processing unit (arithmetic unit), and a RAM 2102, a ROM 2103, and an HD 2104 are used as memories. For example, a hard disk or a solid state drive (SSD) may be used as the HD 2104.

The computer includes the following components: the CPU 2101 that executes a program for implementing modules such as the operation authority receiving module 105, the operation authority management module 110, the configuration information receiving module 115, the configuration information management module 120, the operation instructing module 125, the operation executing module 130, the operation authority evaluating module 135, the Condition-A evaluating module 135A, the Condition-B evaluating module 135B, the user information management module 140, and the target object information management module 150; the RAM 2102 that stores the program or other data; the ROM 2103 in which a program for booting the computer or other data is stored; the HD 2104, which is an auxiliary memory (which may be, for example, a flash memory) that functions as a memory in each of the operation authority management module 110, the configuration information management module 120, the user information management module 140, and the target object information management module 150; a receiving device 2106 that receives data based on user's operations (including, for example, physical movements, voice, or gaze) made on a keyboard, a mouse, a touch screen, a microphone, a camera (including, for example, a gaze detection camera), or other devices; an output device 2105 such as a CRT, a liquid crystal display, or a loudspeaker; a communication line interface 2107 for establishing a connection with a communication network, such as a network interface card; and a bus 2108 that interconnects the above-mentioned components to exchange data. Multiple such computers may be connected to each another via a network.

For features based on a computer program in the exemplary embodiment, a system having the above-mentioned hardware configuration is caused to read the computer program as software, and the exemplary embodiment is implemented by cooperation of the software and hardware resources.

The hardware configuration depicted in FIG. 21 is only illustrative of one exemplary configuration. The exemplary embodiment is not limited to the hardware configuration illustrated in FIG. 21 but may employ any configuration that enables execution of the modules described in the exemplary embodiment. For example, some modules may be implemented by dedicated hardware (such as an application-specific integrated circuit (ASIC)), or some modules may be located within an external system and connected via a communication line. Further, multiple systems illustrated in FIG. 21 may be connected to each another by a communication line so as to operate in cooperation with each other. The above-mentioned configuration may be incorporated in, other than personal computers, in particular, portable information communication devices (including cellular phones, smart phones, mobile devices, wearable computers, and other devices), information home appliances, robots, copiers, facsimiles, scanners, printers, and multifunction machines (image processing apparatuses having two or more of, for example, scanner, printer, copier, and facsimile functions), for example.

The expressions such as “to show” or “shown” as used with reference to the above-mentioned exemplary embodiment may include, other than displaying of information on a display device such as a liquid crystal display, outputting of information as a three-dimensional (3D) image, and may further include using of combinations of, for example, printing on a printing device such as a printer, output of sound to an audio output device such as a loudspeaker, and a vibration.

The program described herein may be provided in the form of being stored on a recording medium, or the program may be provided by means of communication. In that case, for example, the above-mentioned program may be understood as an exemplary embodiment of the invention related to a “computer readable recording medium storing a program”.

The “computer readable recording medium storing a program” refers to a computer readable recording medium on which a program is stored and which is used for purposes such as installing, executing, and distributing the program.

Examples of the recording medium include digital versatile discs (DVDs), such as “DVD-R, DVD-RW, DVD-RAM, or other types of DVDs”, which are standards developed by the DVD Forum, and “DVD+R, DVD+RW, or other types of DVDs”, which are standards developed by the DVD+RW alliance, compact discs (CDs) such as read-only memory (CD-ROM), CD-Recordable (CD-R), and CD-Rewritable (CD-RW) discs, Blu-ray (registered trademark) discs, magneto-optical discs (MOs), flexible disks (FDs), magnetic tapes, hard disks, read-only memories (ROMs), Electrically Erasable Programmable Read-only Memories (EEPROMs (registered trademark)), flash memories, random access memories (RAMs), and secure digital (SD) memory cards.

The above-mentioned program or a portion thereof may be stored on the above-mentioned recording medium for purposes such as saving and distribution. Alternatively, the program may be transmitted by communication, for example, via a transmission medium such as a wired network or a wireless communication network which is used for a local area network (LAN), a metropolitan area network (MAN), a wide area network (WAN), the Internet, an intranet, an extranet, or other networks, or a combination thereof, or may be carried on a carrier wave.

Further, the program mentioned above may constitute a portion or the entirety of another program, or may be stored on a recording medium together with a different program. Alternatively, the program may be stored separately on multiple recording media. Furthermore, the program may be stored in any form, such as compressed or encrypted, as long as the program may be restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives an operation request for an object; and
a permitting unit that applies an operation executing condition to the object for which the operation request has been made to determine whether to permit an operation on the object, the operation executing condition including a first condition associated with an object within an object group in which the object is included and a second condition for each of a plurality of elements constituting the object.

2. The information processing apparatus according to claim 1,
wherein if the first condition is satisfied, the permitting unit determines, for each of the elements and in accordance with the second condition, whether to permit the operation to be executed for the element.

3. The information processing apparatus according to claim 2,
wherein the permitting unit does not permit the operation to be executed for an element that does not satisfy the second condition.

4. The information processing apparatus according to claim 1,
wherein the permitting unit permits a batch operation for the elements constituting the object.

5. The information processing apparatus according to claim 1,
wherein the first condition comprises at least one of a condition determined by a relation between an object and another object within an object group in which an object of interest is included, a condition related to a state of an object to be created in a step within a task process, a condition determined by a state of another step associated with a step or a state of an object to be created in the other step, a condition related to a user who has made the operation request, and a condition related to the object.

6. A non-transitory computer readable medium storing a program causing a computer to execute a process for processing information, the process comprising:
receiving an operation request for an object; and
applying an operation executing condition to the object for which the operation request has been made to determine whether to permit an operation on the object, the operation executing condition including a first condition associated with an object within an object group in which the object is included and a second condition for each of a plurality of elements constituting the object.
